(19) United States
(12) Patent Application Publication
(10) Pub. No.: US 2010/0240806 A1
(43) Pub. Date: Sep. 23, 2010

(54) MATERIALS CONTAINING POLYACTIC ACID AND CELLULOSE FIBERS

(76) Inventor: Tetsuo Kondo, Fukuoka (JP)

Correspondence Address: BIRCH STEWART KOLASCH & BIRCH, PO BOX 747, FALLS CHURCH, VA, 22040-0747, US

(21) Appl. No.: 12/301,977

(22) PCT Filed: May 23, 2007
(86) PCT No.: PCT/JP2007/060503

§ 371 Date: Nov. 21, 2008

(30) Foreign Application Priority Data
May 23, 2006 (JP) 2006 143091

(51) Int. Cl. C08L 1/00

(52) U.S. Cl. 524/35

(57) ABSTRACT

The present invention provides a decomposable resin composition comprising 75% by weight or more of polylactic acid, and 0.05-10% by weight of cellulose nanofibers with respect to the polylactic acid. Preferred cellulose nanofibers are those obtained by conducting of a counter collision treatment on cellulose. Cellulose nanofibers obtained by conducting of the counter collision treatment on bacterial cellulose are more preferred. A molded article prepared using the resin composition of the present invention has good moldability by the action of the cellulose nanofibers to promote crystallization of the polylactic acid, and also has excellent thermal stability and strength.

### TECHNICAL FIELD

The present invention relates to polylactic acid resin compositions and molded articles thereof. In particular, the present invention relates to methods of modifying polylactic acid resins with the use of cellulose nanofibers obtained by conducting a counter collision treatment on cellulose.

### BACKGROUND ART

Extremely thin cellulose nanofibers having high strength, low thermal expansion, and high thermal stability, with a width of approximately 50 nm and a thickness of approximately 10 nm are produced by Acetobactor which is a microorganism. Nanofibers produced by the bacterial bodies immediately form three-dimensional networks to give a membranal article called a pellicle.

A counter collision treatment in water that the present inventors recently reported is a method which enables easy nanomicrofibrillation; in the method, high pressure is applied to natural fiber samples in water to cause the samples from opposite directions to collide with each other at high speeds so that only an interacted part of surfaces of the samples is peeled (Patent Document 1). The treatment is chemical-free and is carried out with low consumption of energy. When the method is applied to the pellicle, first, the networks of the pellicle are disengaged, and bacterial cellulose (BC) nanofibers are dispersed into water. This is expected to produce cellulose nanofibers (=nanocellulose) having a high specific surface area and demonstrating high adsorption power. Currently, use of bacterial cellulose (BC) nanofibers in modification of substrate surfaces by covering the surfaces with cellulose nanofiber coatings is studied (Patent Document 2).

Meanwhile, use of polylactic acid as an alternative material to synthetic polymers is substantially mandatory in automobile industries and other industries in the United States. However, the polylactic acid as a structural material has serious disadvantages such as a low thermal softening point and “brittleness”. To compensate for such disadvantages, a study of compounding microfibrillated cellulose and polylactic acid was conducted, and it was reported that the composite had a strength and a modulus of elasticity that were three or more times higher than those of polylactic acid alone (Non-Patent Document 1). There is also a report on a study of biodegradable materials using microcrystalline cellulose as a reinforcement and polylactic acid as a matrix (Non-Patent Document 2).

### [Patent Document 1]

Japanese unexamined patent publication No. 2002-142796

### [Patent Document 2]

Japanese patent application No. 2006-25869

### [Non-Patent Document 1]

Yano, H. and Nakahara, S.: J. Mater. Sci., 39, 1635 (2004)

### [Non-Patent Document 2]

A. P. Mathew, K. Oksman, M. Sain, J Appl Polym Sci. 97, 2014 (2005)

### DISCLOSURE OF THE INVENTION

However, materials produced by the former method (Non-Patent Document 1) are considered to have low thermal stability, and sufficient mechanical strength is not obtained in the latter method (Non-Patent Document 2). This is considered to be due to insufficient interactions of interfaces between cellulose fibers and PLA (polylactic acid).

The cellulose fibers on which the counter collision treatment in water is conducted, which cellulose fibers are being studied by the present inventors, are fibers having not only a small size that is in nanoscale but also an improved specific surface area, which is another advantage of the counter collision in water. Therefore, the specific surface area is considered to be 10³ times greater than that of the microfibrillated cellulose used in the former report.

The present inventors compounded polylactic acid molecules and cellulose nanofibers prepared by the creative method, namely the counter collision treatment in water, to attempt to prepare a nanocomposite of polylactic acid and cellulose fibers easily and with low consumption of energy, thereby completing the present invention.

### BRIEF DESCRIPTION OF THE DRAWINGS

FIG. 1 is a graph showing an exothermic peak associated with crystallization in a case in which a sample was maintained at 100° C.

FIG. 2 is a graph showing an exothermic peak associated with crystallization in a case in which a sample was maintained at 120° C.

FIG. 3 is a graph showing an exothermic peak associated with crystallization in a case in which a sample was maintained at 120° C.

FIG. 4 is a photograph taken with a polarizing microscope, showing pictures of crystallization of a polylactic acid sample.

FIG. 5 is a photograph taken with a polarizing microscope, showing pictures of crystallization of a polylactic acid sample to which cellulose nanofibers are added.

### DETAILED DESCRIPTION OF THE INVENTION

The present invention provides a decomposable resin composition comprising: 75% by weight or more of a polylactic acid; and 0.05-10% by weight (e.g., 0.1-5% by weight, 0.5-2.5% by weight) of cellulose nanofibers with respect to the polylactic acid. It is preferable that the cellulose nanofibers be those obtained by conducting a counter collision treatment on cellulose. It is more preferable that the cellulose nanofibers be those obtained by conducting the counter collision treatment on bacterial cellulose.

The term “polylactic acid” as used herein means, except for special cases, a polymer having a repeat unit of lactic acid. The polylactic acid includes lactic acid homopolymers, lactic acid copolymers (e.g., lactic acid-hydroxycarboxylic acid copolymers), and polymer blends or polymer alloys that are mixtures of the lactic acid homopolymers and the lactic acid copolymers. The polylactic acid can be prepared using, as feedstock, L-lactic acid, D-lactic acid, DL-lactic acid, lactide which is a cyclic dimmer of lactic acid, or mixtures thereof. The lactic acid copolymers can be prepared using those listed above including L-lactic acid, and, as the hydroxycarboxylic acid, glycolic acid, 3-hydroxybutyric acid, 4-hydroxybutyric acid, 4-hydroxyvaleric acid, 5-hydroxyvaleric acid, 6-hydroxycarboxylic acid, cyclic ester intermediate of hydroxycarboxylic acid (e.g., glycolide which is a dimmer of glycolic acid, ε-caprolactone which is a cyclic ester of 6-hydroxycaproic acid), or mixtures thereof.

The “polylactic acid” of the present invention is not particularly limited in terms of a proportion of the polylactic acid used, molecule structure, or molecular weight, as long as it has biodegradability and moldability. Generally, for the polylactic acid to be moldable, a weight average molecular weight of a resin component in the resin composition is 10000-500000, preferably 30000-400000, more preferably 50000-300000. In the present invention, those having a weight average molecular weight of 130000 can be suitably used.

The resin composition of the present invention may contain, for instance, 75% by weight or more of the polylactic acid with the molecular weight specified above. Substantially, a polylactic acid-containing resin composition consisting of a polylactic acid and cellulose nanofibers, which resin composition comprises 0.05-10% by weight (e.g., 0.1-5% by weight, 0.5-2.5% by weight) of the cellulose nanofibers with respect to the polylactic acid is an example of the present invention. Further, various additives that are added to conventional resin compositions may be added to the resin composition of the present invention in addition to the polylactic acid and the cellulose nanofibers. In the present invention, especially the lactic acid homopolymers can be suitably used as the polylactic acid.

The term “cellulose” alone as used herein includes, except for special cases, plant-derived cellulose, bacterial cellulose, animal-derived cellulose, cellulose fibers, crystalline cellulose and the like, and origins, preparation methods, properties and the like are not particularly limited.

The term “cellulose nanofiber” as used herein means cellulose fibers having an average width of 100 nm or below and an average thickness of 100 nm or below. The average width and the average thickness of the cellulose fibers can be measured by methods known to persons skilled in the art, such as methods using a light scatter, a laser microscope, or an electron microscope. The average width is a mean value obtained by measuring some of longer ones of lengths that are to be measured, for instance 10-200 lengths, preferably 30-80 lengths, and then averaging the lengths thus measured. The average thickness is a mean value obtained by measuring some of shorter ones of the lengths that are to be measured, for instance 10-200 lengths, preferably 30-80 lengths, and then averaging the lengths thus measured. Preferred examples of the cellulose nanofibers to be used in the present invention include cellulose nanofibers having an average width and an average thickness that are equal to or below those of bacterial cellulose (e.g., an average width of 25 nm or below, preferably 20 nm or below, more preferably 15 nm or below, most preferably 8-12 nm), with the average thickness of 8-12 nm.

The term “bacterial cellulose” as used herein means, except for special cases, cellulose produced by microorganisms (polysaccharide having β-1,4-glucoside bond as a main form of bond), and, unless otherwise specified, indicates those in a form of gel membranes (pellicle). The bacterial cellulose can be prepared by methods that are well known to persons skilled in the art. Acetobactor, such as Acetobactor xylinum (also called Gluconacetobactor xylinus), Acetobactor pasteurianum, and Acetobactor rancens, Sarcina ventriculi, Bacteirum xyloides, Pseudomonas bacteria, Agrobacterium bacteria or the like can be used as cellulose-producing bacteria. Culture solutions, culture conditions and the like to be used can be appropriately determined by persons skilled in the art.

The term “counter collision (treatment)” as used herein means, except for special cases, a wet pulverization technique by which a dispersion liquid of polysaccharides is jetted from a pair of nozzles at a high pressure of 70-250 MPa, and the jet streams are cause to collide with each other to pulverize cellulose fibers. This technique is specifically disclosed in Japanese unexamined patent publication No. 2005-270891.

The counter collision treatment is a wet microparticulation technique using collision energy of ultrahigh-pressure water to make materials microparticulated. Comparing to other pulverization techniques, bead mills, jet mills, stirring machineres, high-pressure homogenizer and the like, the counter collision treatment has various advantages. For instance, since the counter collision treatment does not use a milling medium, no contaminating of abrasion powders of the medium would occur. Further, compared with the medium milling system, a uniform and sharp particle size distribution is obtained. Furthermore, it is easy to conduct consecutive processing and to increase capacities. Other advantages include a shorter period of contact time with the atmosphere to make it possible to minimize oxidation of treated articles.

High-pressure cleaners or high-pressure homogenizers for pulverization, dispersion, emulsification and the like can be used as an apparatus for the counter collision treatment.

In the counter collision treatment, cellulose is suspended in water. If necessary, the cellulose may be pulverized in advance. It is preferable that a dispersion concentration of this suspension be an appropriate concentration to allow the suspension to pass through pipes as a dispersion slurry, preferably 0.1-10% by mass.

In the counter collision treatment, a dispersion liquid is jetted at a high pressure of 70-250 MPa from a pair of nozzles, and jet streams are caused to collide with each other to be pulverized. In the treatment, it is possible to pulverize cellulose fibers to an average particle diameter to ¼ or below or to 10 μm and, furthermore, to prevent decrease in the degree of polymerization of the cellulose, by either adjusting angles of the high-pressure jet streams of the dispersion liquid jetted from the pair of nozzles in such a manner that the jet streams meet and collide at appropriate angles at a point ahead of each outlet of the respective nozzles, or adjusting the number of jetting of the high-pressure fluid to adjust the number of pulverization.

A collision angle θ can be set to 95-178°, for instance 100-170°. If the streams are arranged to meet at an angle smaller than 95°, for instance at 90°, structurally, more portions of meeting dispersion liquid are likely to collide directly with a wall of a chamber more readily, and decrease in the degree of polymerization of the cellulose more often exceeds 10% by a single collision. On the other hand, if the angle is greater than 178°, for instance if the streams are arranged to meet at 180° to collide head-on with each other, energy of the collision is so high that the degree of polymerization may decrease significantly by a single collision.

The number of collisions may be 1-200 times, for instance 5-120 times, -60 times, -30 times, -15 times, -10 times. If the pulverization is carried out many times, decrease in the degree of polymerization of the cellulose may exceed 10%.

The collision angle and/or the number of collisions can be set appropriately in consideration of decomposition efficiency of cellulose and the like. Adjusting the collision angle and/or the number of collisions can adjust the average particle length of the cellulose after the collision treatment to ¼ or below, ⅕- 1/100, ⅙- 1/50, 1/7- 1/20 of an average particle length before the treatment. Similarly, the average particle length can be adjusted to 10 μm or below, 0.01-9 μm, 0.1-8 μm, 0.1-5 μm. The particle width of the cellulose fibers is at a right angle with respect to the average particle length of the cellulose fibers. This width is called an average particle width, and adjusting the collision angle and/or the number of collisions can also adjust the average particle width to 10 μm or below, 0.01-9 μm, 0.1-8 μm.

A temperature of a treated article increases as the number of counter collision treatments increases. Thus, if necessary, treated articles having undergone a single collision treatment may be cooled to, for instance, 4-20° C. or 5-15° C. The apparatus for the counter collision treatment may be provided with a cooling equipment.

Examples of a method for collecting only portions with especially fine cellulose fibers from the treated articles in the present invention include centrifugal separation. The treated articles are subjected to the centrifugal separation, and the resulting supernatant liquid is separated to give fine cellulose particles with an average particle length below 1 μm.

Note that bacterial cellulose having undergone no counter collision treatment cannot be mixed with PLA, because a strong gel membrane (pellicle) with networks of fibers is formed.

It is preferable that the cellulose nanofibers have a dimension of several tens of nanometers so that they can be used suitably in the present invention. The width of the fibers can be easily and promptly controlled in nanoorder by changing the number of counter collisions in water. Normally, cellulose fibers of bacterial cellulose are pulverized to a nanosize by five or more counter collisions, and further counter collisions subsequent to the five or more counter collisions contribute to modification of surface conditions in addition to the pulverization. If the size of the fibers is in nanoorder, not only the size but also fluff on surfaces of the fibers due to the counter collisions in water, i.e., an increased specific surface area of the surfaces of the fibers, are considered to give the resulting resin composition advantages such as excellent moldability, thermal stability, and strength.

Since the specific surface area of the nanofibers can be controlled by the number of counter collisions, cellulose fibers of various origins with widths modified in nanoorder are applicable to the present invention. For instance, an aggregate of molecules of bacterial cellulose surfaces is in a triclinic crystalline form called Iα (alpha), even if the surfaces are formed of the same cellulose molecules. On the other hand, an aggregate of molecules of plant-derived surfaces is in a monoclinic crystalline form called Iβ (beta). Thus, the respective surfaces of the nanofibers have different properties. To apply various cellulose fibers to the present invention, it should be taken into consideration that the surface properties vary according to the origins of the cellulose materials.

The resin composition of the present invention can be prepared by mixing (blending) the polylactic acid and the cellulose nanofibers. To uniformly disperse the cellulose nanofibers with respect to the polylactic acid, it is normally required to add water. Mixing at the stage of counter collision in water enables nanodispersion. If a blend suspension of bacterial cellulose and PLA is pulverized and, at the same time, nanodispersed by the counter collision, it is possible to visually determine whether a uniform mixture is obtained.

A mix ratio of the cellulose nanofibers to the polylactic acid in the resin composition of the present invention can vary, but addition of 0.05-10% by weight (e.g., 0.1-5% by weight, 0.5-2.5% by weight) cellulose nanofibers with respect to the polylactic acid can produce advantages described below. The surfaces of the cellulose nanofibers obtained by the counter collision have fluff of a size of molecules (sub-nanometer size) as well as fluff of nanosize, and a combination of the fluff of a size of molecules and the fluff of nanosize gives a large specific surface area to make it possible to produce strong adsorption power. Therefore, addition of a large amount of cellulose nanofibers is not considered necessary to obtain the advantages of the nanofibers. On the other hand, addition of a relatively large amount (e.g., over 10% by weight) of cellulose nanofibers may increase difficulty in molding processing, because the resin composition does not melt completely at 200° C. It is considered that the addition of a large amount of cellulose nanofibers merely causes partial melting of regions of the polylactic acid that do not interact with the cellulose nanofibers, and regions of the polylactic acid that interact with the fibers have high compatibility due to strong interaction, and therefore such regions that contain only the polylactic acid can no longer be crystallized. In other words, when the amount added is increased, the crystallization is considered to depend more on properties of the cellulose nanofibers (thermally stable up to 300° C.). In view of the foregoing, the addition of a large amount of nanofibers makes it possible to provide strength (e.g., structural thermal stability and Young's modulus) in a different point of view from conventional polylactic acid.

Molded articles prepared using the resin composition of the present invention have good moldability and excellent thermal stability and strength due to a crystallization promoting effect of the cellulose nanofibers on the polylactic acid.

According to the study by the present inventors, a period of time that elapsed before an exothermic peak associated with crystallization of the polylactic acid (=crystallization induction time) in a case in which the sample was maintained at 100° C. was 5.8 minutes for the polylactic acid alone, but the period of time was shortened to 1.8 minutes by the addition of 10% by weight cellulose nanofibers with respect to the polylactic acid (refer to Example). This is considered to be due to the cellulose nanofibers acting as a crystal nucleating agent on the polylactic acid. Conventionally, an annealing treatment for crystallization after molding is required to allow properties of the polylactic acid to be developed sufficiently, and this has a problem of low productivity. Specifically, the polylactic acid crystallizes very sluggishly and slowly, and the crystallization is, actually, not completed at a stage of making final products after the molding processing. Thus, the products do not have expected thermal stability. However, if the cellulose nanofibers enables prompt development of crystallization, the crystallization at the stage of the molding processing is more promoted than the conventional cases. This makes it possible to obtain resin products having higher thermal stability.

Thermal stability of the molded articles prepared using the resin composition of the present invention can be evaluated on the basis of tensile strength under application of heat, and deflection temperature under load.

Further, according to the study by the present inventors, tensile strength of a melt-molded article of the resin composition of the present invention was not inferior to those of general-purpose plastics (refer to Example). Although there is a report that tensile strength decreased with higher ratios of mixed microcrystalline cellulose to the polylactic acid (refer to Non-Patent Document 2), tensile strength may increase with addition of the cellulose nanofibers to the polylactic acid in the present invention. This difference is considered to be due to presence of different interactions between the cellulose nanofibers and the polylactic acid from those between microcrystalline cellulose and the polylactic acid, although the cellulose nanofibers and the microcrystalline cellulose are both cellulose.

The molded articles prepared using the resin composition of the present invention have excellent decomposability. Decomposability (sometimes expressed as “biodegradability”) indicates functions of an organic material to keep, while it is used for a particular purpose, material properties suitable for the purpose, and to become brittle under natural environment or in vivo environment after accomplishment of the purpose or after disposal, Persons skilled in the art would appropriately evaluate the decomposability. For instance, the decomposability can be evaluated by JIS K 6950 (ISO 14851), determination of the ultimate aerobic biodegradability of plastic materials in an aqueous medium (method by measuring the oxygen demand in a closed respirometer), JIS K 6951 (ISO 14852), determination of the ultimate aerobic biodegradability of plastic materials in an aqueous medium (Method by analysis of evolved carbon dioxide), JIS K 6953 (ISO 14855) determination of the ultimate aerobic biodegradability and disintegration of plastic materials under controlled composting conditions (Method by analysis of evolved carbon dioxide), or the like.

Accordingly, the present invention provides: a method of promoting crystallization of a resin composition containing a polylactic acid, comprising adding 0.05-5% by weight, with respect to the polylactic acid, of a cellulose nanofiber; a method of enhancing thermal stability of a resin composition containing a polylactic acid, comprising adding 0.05-10% by weight, with respect to the polylactic acid, of a cellulose nanofiber; a method of enhancing strength of a resin composition containing a polylactic acid, comprising adding 0.05-10% by weight, with respect to the polylactic acid, of a cellulose nanofiber; and a method of improving moldability of a resin composition containing a polylactic acid, comprising adding 0.05-10% by weight, with respect to the polylactic acid, of a cellulose nanofiber.

The present invention provides a molded article containing the resin composition of the present invention. Molding can be carried out by various processes such as inflation molding, calender molding, balloon molding, blow molding, compression molding, injection molding, and extrusion molding. As described above, the resin composition of the present invention can be molded in conventional molding cycles applied to conventional general-purpose resins, without the use of a special process such as an annealing treatment, and the resulting molded articles have excellent thermal stability and sufficient strength. Therefore, the molded articles of the present invention can be used in interior materials, shock absorbers, general-purpose plastics, and food containers. It is also expected to apply the resin composition of the present invention using bacterial cellulose nanofibers to biomaterials (e.g., a step toward regenerative medicine) to take advantage of the biocompatibility of the bacterial cellulose.

### EXAMPLE

### 1. Method

1.1 Preparation of Samples

### [Cellulose Nanofibers]

Acetobactor xylinum, or Gluconacetobactor xylinus, (production strain: ATCC 53582) was cultured (a medium for bacterial cellulose culture was prepared in accordance with Hestrin, S. & Schramm, M. (1954) Biochem. J. 58, 345-352), and the resulting cellulose pellicle was cut into 1 cm square pieces, suspended in water, and then subjected to counter collision (apparatus used: Altimizer (Sugino Machine Limited), pressure: 200 Mpa, number of collisions: 20, solid concentration in the suspension: approximately 0.4%) to give a cellulose nanofiber suspension.

The resulting suspension was freeze-dried, and then used as cellulose nanofibers in the following tensile experiment and thermal analysis (Procedure 1).

The foregoing procedure was repeated, except that the number of collisions was 60, to prepare a cellulose nanofiber suspension. The cellulose nanofiber suspension was used in thermal analysis (Procedure 2).

[Samples for Tensile Test]

Samples were prepared by the following procedure. A polylactic acid powder having a number average molecular weight of 90000 and a weight average molecular weight of 130000 (Terramac (product name) of Unitika. Ltd.) was used.

(1) Cellulose nanofibers obtained by a counter collision treatment was added to the polylactic acid powder (1% by weight with respect to the polylactic acid).

(2) Deionized water was added and mixed well with the polylactic acid powder and the cellulose nanofibers.

(3) The sample was dried at 105° C. to remove moisture from the sample.

(4) The sample was melted at 200° C. and molded with a frame.

(5) The molded article was cooled with water to give a specimen.

(6) A tensile strength was measured with a tensile tester.

[Samples for Thermal Analysis]

Samples were prepared by the following two procedures.

Procedure 1

(1) A polylactic acid powder, deionized water, and cellulose nanofibers (10% by weight with respect to the polylactic acid) obtained by a counter collision treatment were mixed and shaken well.

(2) The sample was quickly frozen with liquid nitrogen.

(3) The frozen sample was freeze-dried.

(4) Thermal analysis was conducted on the dried sample by DSC.

Procedure 2

A cellulose nanofiber suspension was added to 2 g polylactic acid powder such that a weight of the nanocellulose fibers was 0.2 g or 0.02 g. Then, 400 mL deionized water was added to each of the mixtures and suspended at 20000 rpm for 1 minute in a high-speed homogenizer. This suspension was subjected to centrifugal separation at 3000 rpm for 10 minutes, and a precipitate was collected and dried at 40° C. to give a sample containing the polylactic acid and the nanocellulose at a ratio (weight) of 10:1 (polylactic acid: nanocellulose), and a sample containing the polylactic acid and the nanocellulose at a ratio (weight) of 100:1 (polylactic acid: nanocellulose).

As comparative samples, samples to which a talc generally used as an additive to modify high molecules was added in place of the cellulose nanofibers were prepared as follows.

To 2 g polylactic acid powder, 0.2 g or 0.02 g talc (Wako Pure Chemical Industries, Ltd.) was added. Then, 400 mL deionized water was added to each of the mixtures and suspended at 20000 rpm for 1 minute in a high-speed homogenizer. The resulting suspension was subjected to centrifugal separation at 3000 rpm for 10 minutes, and a precipitate was collected and dried at 40° C. to give two samples; one of the samples contained the polylactic acid and the talc at a ratio of 10:1 (polylactic acid: talc), and the other one of the samples contained the polylactic acid and the talc at a ratio of 100:1 (polylactic acid: talc).

1.2 Tensile Strength Test

Tensile strength of the specimen (having a thickness of 0.8 mm, a width of 4-5 mm, and a length of 6-7 mm) was measured with Strograph E-S (Toyo Seiki Seisaku-Sho, Ltd.). A tensile speed of the sample was 5 mm/min.

1.3 A Period of Time that Elapsed Before an Exothermic Peak Associated with Crystallization was Exhibited (=Crystallization Induction Time)

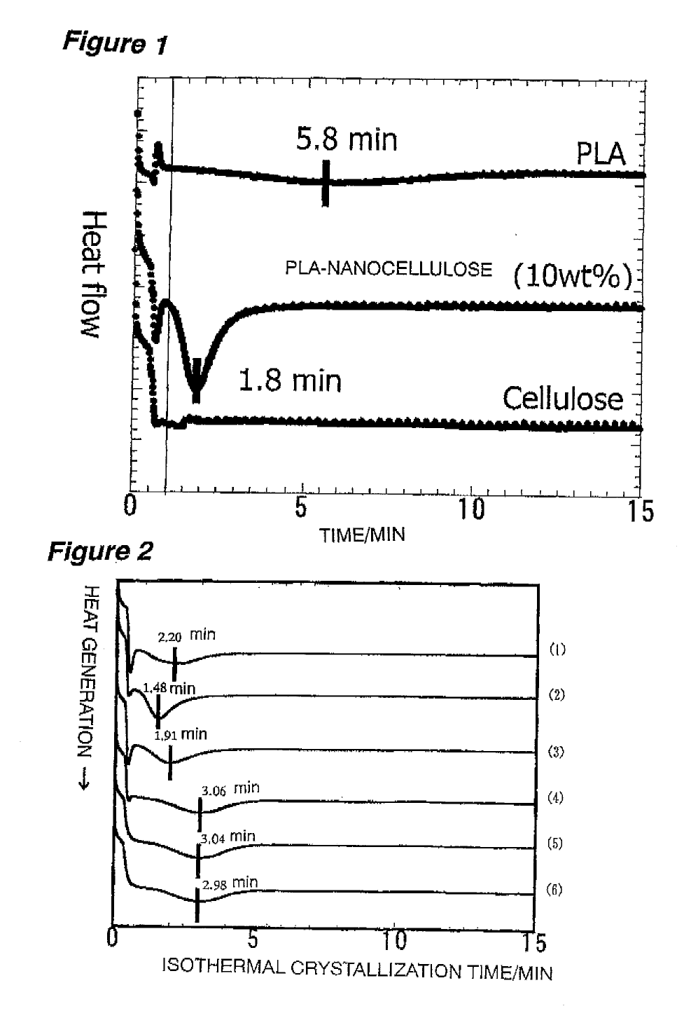

The samples prepared by Procedure 1 were left at 200° C. for 5 minutes using DSC. Then, the samples were cooled to 100° C. at 200° C./min, and a crystallization induction time at 100° C. was measured (refer to FIG. 1).

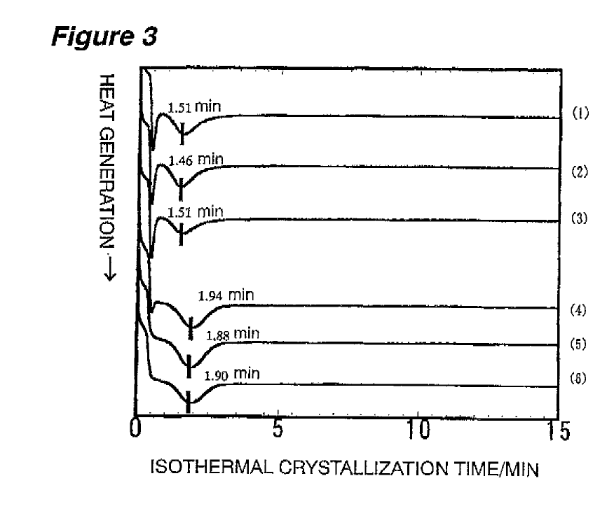

The samples and the comparative samples prepared by Procedure 2 were put in sample pans for DSC (PERKIN ELMER/DSC7) in an amount of approximately 2±0.1 mg. Three sets for each were prepared. Using the sample pans, the samples were left at 200° C. for 3 minutes by DSC and then cooled to 120° C. at 200° C./min, and isothermal crystallization was carried out for 15 minutes. Then, a crystallization induction time at 120° C. was measured (refer to FIG. 2 for the sample containing polylactic acid and nanocellulose at a ratio of 100:1 and a sample containing polylactic acid and talc at a ratio of 100:1, and refer to FIG. 3 for the samples with the ratio of 10:1).

The crystallization induction time is a period of time that elapsed before an exothermic peak associated with crystallization was exhibited in isothermal crystallization. A shorter crystallization induction time indicates that the polylactic acid is crystallized more easily, and ease of crystallization leads to improvement in molding speed and thermal stability of the polylactic acid.

### 2. Results and Discussion

2.1 Tensile Strength

Table 1 compares tensile strengths of the polylactic acid used in the present experiment, the polylactic acid/cellulose nanofibers composite used in the present experiment, general-purpose plastics, and polylactic acid/microcrystalline cellulose composites. As shown in Table 1, the tensile strength decreased with higher ratios of the mixed microcrystalline cellulose in the polylactic acid. In the present experiment, however, the tensile strength increased with the addition of the cellulose nanofibers to the polylactic acid. This suggests that, although the cellulose nanofibers and the microcrystalline cellulose are both cellulose, there is a different interaction between the cellulose nanofibers and the polylactic acid from that between the microcrystalline cellulose and the polylactic acid. Further, the tensile strength of the polylactic acid/cellulose nanofibers composite is not inferior to those of the general-purpose plastics.

TABLE 1
Comparison of tensile strengths of the polylactic acid used
in the present experiment, the polylactic acid/nanocellulose
used in the present experiment, general-purpose plastics,
and polylactic acid/microcrystalline cellulose

| | | | TENSILE |
|---|---|---|---|
| | | | STRENGTH/Mpa |
| PRESENT | POLYLACTIC ACID (PLA) | | 46.7 |
| EXPERIMENT | PLA-NANOCELLULOSE | | 49.3 |
| (HIGHEST | (1 wt %) | | |
| VALUE) | | | |
| REFERENCE | *PLA-MICROCRYSTALLINE | | 49.6 |
| VALUE | CELLULOSE (0%) | | |
| | *PLA-MICROCRYSTALLINE | | 38.2 |
| | CELLULOSE (10%) | | |
| | *PLA-MICROCRYSTALLINE | | 37.8 |
| | CELLULOSE (15%) | | |
| | *PLA-MICROCRYSTALLINE | | 36.2 |
| | CELLULOSE (25%) | | |
| | **GENERAL- | PET | 56.8 |
| | PURPOSE | PS | 47.0 |
| | | PP | 30.3 |
| | | PE | 11.8 |

*A. P. Mathew, K. Oksman, M. Sain, J. Appl. Sci. (2005), 97, 2014
**“Development and application of polylactic acid green plastics” Frontier Publishing.
PET: polyethylene terephthalate
PS: polystyrene
PP: polypropylene
PE: polyethylene

2.2 Crystallization Induction Time

The results are shown in FIGS. 1-3.

As shown in FIG. 1, a period of time that elapsed before an exothermic peak associated with crystallization of polylactic acid (=crystallization induction time) in a case in which the sample was left at 100° C. was 5.8 minutes for the polylactic acid alone, but the time was shortened to 1.8 minutes by the addition of the cellulose nanofibers. This is considered to be due to the cellulose nanofibers acting as a crystal nucleating agent on the polylactic acid. Conventionally, an annealing treatment for crystallization after molding is required to allow properties of the polylactic acid to be developed sufficiently, and this has a problem of low productivity. With regard to this point, the results of the present experiment suggest that the cellulose nanofibers promote crystallization of the polylactic acid to significantly shorten an annealing time and therefore to improve productivity. Furthermore, the promotion of crystallization of the polylactic acid is considered to lead to improvement in thermal stability.

As shown in FIGS. 2 and 3, the crystallization induction time in the case in which the sample was left at 120° C. was an average of 1.9 minutes for the sample to which 1% by weight cellulose nanofibers with respect to the polylactic acid was added, and an average of 1.5 minutes for the sample to which 10% by weight cellulose nanofibers with respect to the polylactic acid was added. Both results are shorter than those of the comparative talc-added samples. Note that, in FIGS. 2 and 3, (1)-(3) show exothermal behavior of the samples to which the cellulose nanofibers were added, and (4)-(6) show exothermal behavior of the talc-added samples.

### 3. Observation of Polylactic Acid Crystallization Behavior

Observation of crystallization behavior was conducted on a sample with the polylactic acid alone, and a sample prepared by adding 1% by weight cellulose nanofibers (obtained by drying a cellulose nanofiber suspension prepared by the same method as that described above, except that the pressure was 100 MPa, and the number of collisions was 5) with respect to the polylactic acid.

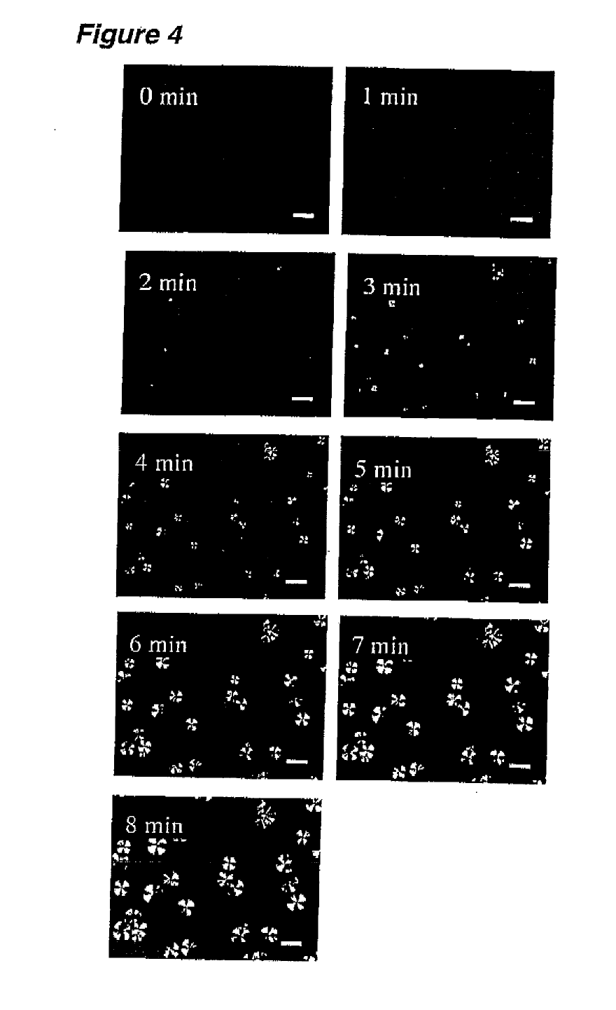

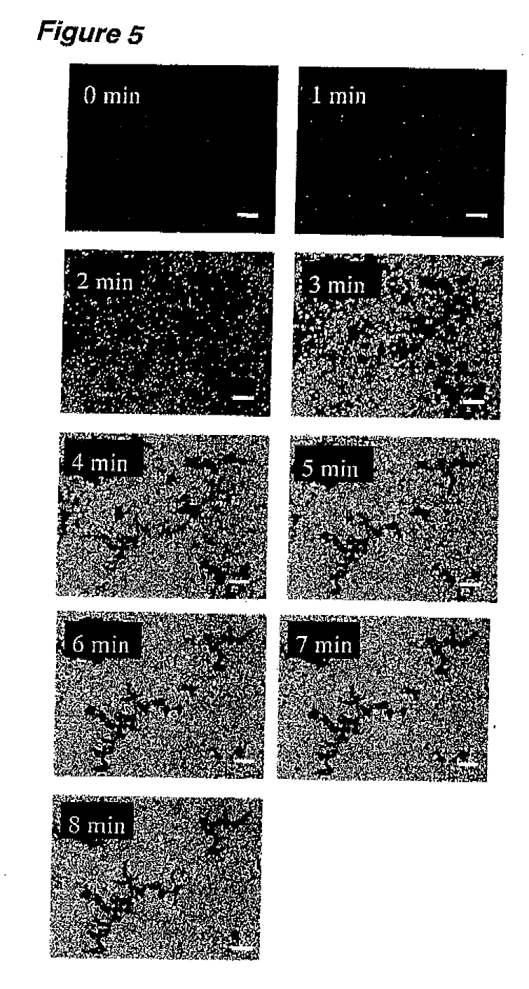

Each of the sample with the polylactic acid alone and the sample to which the cellulose nanofibers were added was melted at 200° C. and then subjected to isothermal crystallization at 120° C. Then, pictures of crystallization were taken with a polarizing microscope every one minute after the isothermal crystallization started. FIGS. 4 and 5 show the pictures taken (in FIGS. 4 and 5, a bar at a lower right section of each picture shows a scale of 100 μm). As shown in FIGS. 4 and 5, the sample to which the cellulose nanofibers were added (FIG. 5) formed crystal faster than the sample with the polylactic acid alone (FIG. 4). This indicates that the cellulose nanofibers acted as a crystal nucleating agent for the polylactic acid to improve a crystallization speed of the polylactic acid.

### 4. Conclusion

It was found that blending cellulose nanofibers obtained by the counter collision treatment with polylactic acid improved the tensile strength of the polylactic acid, and that the cellulose nanofibers acted as a crystal nucleating agent for the polylactic acid to improve the crystallization speed of the polylactic acid. The cellulose nanofibers improve the thermal stability and strength of the polylactic acid, which are important properties for structural materials, and, furthermore, biodegradability of the polylactic acid is maintained. It is recognized from the foregoing that blending the polylactic acid with the cellulose nanofibers is significantly effective for expanding applicable fields of the polylactic acid.

1. A decomposable resin composition comprising:
75% by weight or more of a polylactic acid; and
0.05% by weight to 10% by weight of a cellulose nanofiber with respect to the polylactic acid.

2. The resin composition of claim 1, wherein the cellulose nanofiber is obtained by conducting a counter collision treatment on a cellulose.

3. The resin composition of claim 2, wherein the cellulose nanofiber is obtained by conducting the counter collision treatment on a bacterial cellulose

4. A molded article comprising the resin composition of any one of claims 1 to 3.

5. A method of promoting crystallization of a resin composition containing a polylactic acid, the method comprising adding 0.05% by weight to 5% by weight, with respect to the polylactic acid, of a cellulose nanofiber.

6. A method of enhancing thermal stability of a resin composition containing a polylactic acid, the method comprising adding 0.05% by weight to 10% by weight, with respect to the polylactic acid, of a cellulose nanofiber.

7. A method of enhancing strength of a resin composition containing a polylactic acid, the method comprising adding 0.05% by weight to 10% by weight, with respect to the polylactic acid, of a cellulose nanofiber.

8. A method of improving moldability of a resin composition containing a polylactic acid, the method comprising adding 0.05% by weight to 10% by weight, with respect to the polylactic acid, of a cellulose nanofiber.

9. A polylactic acid-containing resin composition comprising a polylactic acid and a cellulose nanofiber, the resin composition comprising 0.05% by weight to 10% by weight of the cellulose nanofiber with respect to the polylactic acid.
